(19) United States
(12) Patent Application Publication
(10) Pub. No.: US 2005/0117075 A1
(43) Pub. Date: Jun. 2, 2005

(54) Rear projection system

(75) Inventors: Adrianus Johannes Stephanes Maria De Vaan, Eindhoven (NL); Everardus Gerardus Van Leusden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/507,195

(22) PCT Filed: Feb. 5, 2003
(86) PCT No.: PCT/IB03/00389

(30) Foreign Application Priority Data
Mar. 14, 2002 (EP) 02076035.1

(51) Int. Cl. H04N 5/64

(52) U.S. Cl. 348/787; 348/789

(57) ABSTRACT

Rear projection system comprising a rear projection cabinet with a rectangular opening, a projection screen covering said opening and a projector located at least partly in said cabinet, wherein the sides of the rectangular opening are curved. The sides of the opening are curved at least as much as curvatures of sides of an image to be projected by the projector, which curvatures are due to distortion caused by the projector.

The invention relates to a rear projection system comprising a rear projection cabinet with a rectangular opening, a projection screen covering said opening and a projector located at least partly in said cabinet.

Such a device which is known from U.S. Pat. No. 5,289,287 projects an image by means of the projector on the projection screen from a side remote from the viewing side of the projection screen.

These kinds of projection systems are becoming interesting for television and monitor applications. In such applications it is important to obtain a visible image which is free from distortion. This is important, especially for rear projection monitor applications because the projected monitor image for such applications is normally a little smaller than the visible rear projection screen so as to ensure that all information of the image, like characters and numbers, is visible. Furthermore, straight lines are often present in the image in monitor applications so that a distortion, for example bent lines, will be easily observable. In the projection system according to the above-mentioned U.S. Pat. No. 5,289,287 a relatively expensive projector needs to be used to ensure that the projection lens system thereof causes very small distortions. However, lens systems with very small distortions are relatively expensive.

It is an object of the invention to provide a rear projection system wherein a relatively low-quality, inexpensive projector can be used while still obtaining a visible image which is free from distortion.

The object of the invention is achieved in that the sides of the rectangular opening are curved.

By curving the sides of the rectangular opening, the shape of said opening can be made the same as the shape of the image with the distortions caused by, for example, the projection lens system of the projector. Instead of avoiding a distortion as in the prior-art systems, the opening is adapted to the distortion. In such a case, the eye reference for a straight line will disappear and the distortion of the projected image seen in the opening with the curved sides becomes invisible to the human eye.

An embodiment of the rear projection system according to the invention is characterized in that the sides of the opening are curved at least as much as curvatures of sides of an image to be projected by the projector, which curvatures are due to distortion caused by the projector.

By giving the sides of the opening a curvature which is curved at least as much as a distorted image, it is guaranteed that the distortion of the projected image will be invisible to the human eye.

Another embodiment of the projection system according to the invention is characterized in that the sides are curved towards a centre of the opening.

In the normally used projection lens systems of relatively low quality, a distortion of the image will occur at which the middle of each side of a projected image will be located closer to the centre of the image. By giving each side of the opening a curvature towards the centre of the opening, the distortion can be made invisible.

The rear projection system according to the invention will be explained in more detail with reference to the drawings in which

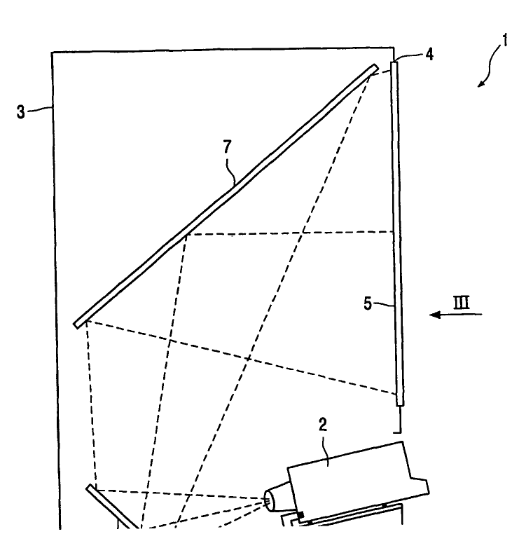

FIG. 1 is a diagrammatic view of a rear projection system,

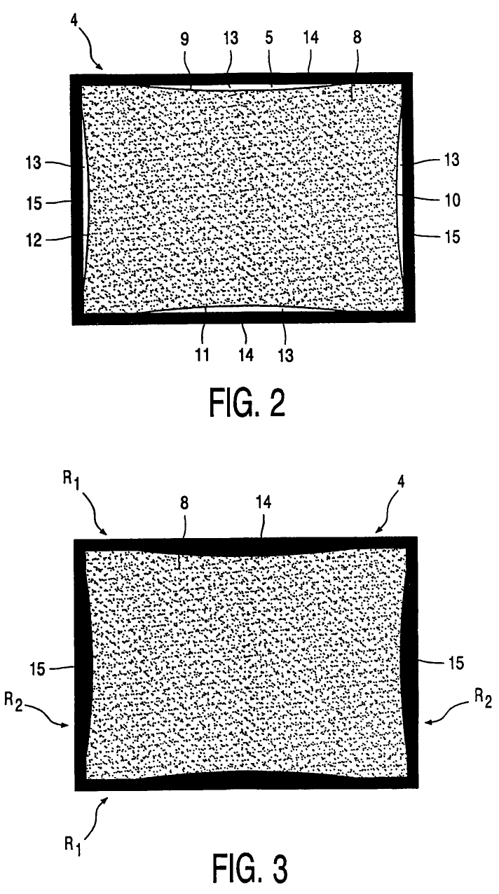

FIG. 2 is a front view of an opening in a cabinet of a prior-art rear projection system, and

FIG. 3 is a front view of an opening in a cabinet of a rear projection system according to the invention.

A rear projection system 1 according to the invention includes a dockable projector 2 which can be manually inserted into a cabinet 3 for rear projection viewing. The cabinet 3 has an opening 4 in which a projection screen 5 is mounted. Two mirrors 6 and 7 are located in the cabinet 3. Light coming from the projector 2 is reflected upwards by means of the mirror 6. Light reflected by the mirror 6 is reflected forward by means of the mirror 7 to the rear of the rear projection screen 5. The rear projection system 1 is described in more detail in the above-mentioned U.S. Pat. No. 5,289,287.

FIG. 2 is a front view of the opening 4 and the projection screen 5 of a rear projection system according to the prior art. If the projector 2 and especially a projection lens system located in said projector 2 have a relatively low quality, an image 8 projected by means of the projector 2 on the rear side of the projection screen 5 will have the shape as shown in FIG. 2 wherein edges 9, 10, 11, 12 of said image 8 are curved towards the centre of the opening 4. As can be seen in FIG. 2, parts 13 of the projection screen 5 are visible between the rectangular sides 14, 15 of the opening 4 on which no image is projected. These parts 13 are clearly visible to the human eye and will give the impression of a distorted image.

FIG. 3 is a front view of the projection system 1 according to the invention, in which the sides 14 of the rectangular opening 4 have a curvature with a radius R1 and the sides 15 of the rectangular opening 4 have curvatures with a radius R2.

It should be noted that both in FIG. 2 and in FIG. 3, the parts 13 are relatively large and the radii R1 and R2 are relatively small so as to give a good impression about the problem of the prior-art projection system and to provide the solution by the rear projection system 1 according to the invention. In practice, the radii R1, R2 will be much larger.

When an image 8, similar to the image 8 of FIG. 2, is projected by the rear projection system 1 according to the invention on the rear side of the projection screen 5, the human eye will get the impression of an image which is free from distortion.

The distortion can be indicated by means of a maximum percentage of deviation from a perfectly rectangular window. In the prior-art system shown in FIG. 2, the allowable distortion of the image is <0.5% for high-end monitor applications and <1% for televisions with monitors as featured applications. In the system according to the invention, the distortion of the image may be, for example, 1.5 to 3% while still having the impression of an image which is free from distortion.

If the projector 2 creates an image 8 wherein the edges 9, 10, 11, 12 are curved away from the centre of the opening 4, the edges 14, 15 of the opening 4 need to be curved accordingly.

The specific shape of the opening 4 depends on the projector and more specifically on the distortions caused by the lens system of the projector of the rear projection system.

Instead of a dockable projector, it is also possible to mount the projector permanently and invisibly in the cabinet.

1. A rear projection system comprising a rear projection cabinet with a rectangular opening, a projection screen covering said opening and a projector located at least partly in said cabinet, characterized in that the sides of the rectangular opening are curved.

2. A rear projection system as claimed in claim 1, characterized in that the sides of the opening are curved at least as much as curvatures of sides of an image to be projected by the projector, which curvatures are due to distortion caused by the projector.

3. A rear projection system as claimed in claim 1, characterized in that the sides are curved towards a centre of the opening.
